(19) United States
(12) Patent Application Publication
(10) Pub. No.: US 2024/0034682 A1
(43) Pub. Date: Feb. 1, 2024

(54) SPENT COFFEE GROUNDS BRICK

(71) Applicant: YOUNGROK CHOI, Seoul (KR)

(72) Inventor: YOUNGROK CHOI, Seoul (KR)

(21) Appl. No.: 17/899,803

(22) Filed: Aug. 31, 2022

(30) Foreign Application Priority Data
Jul. 26, 2022 (KR) 10-2022-0092665

(51) Int. Cl. C04B 33/132

(52) U.S. Cl. CPC C04B 33/132

(57) ABSTRACT

Disclosed here is a spent coffee ground brick. The spent coffee ground brick includes cement, coarse aggregate, fine aggregate, and water, wherein the fine aggregate includes spent coffee grounds. With excellent durability and heat resistance, the spent coffee ground brick can be used in high-temperature environments while it can be manufactured using existing brick manufacturing machines and is environmentally favorable.

### CROSS-REFERENCE TO RELATED APPLICATION(S)

This application is based on and claims priority under 35 U.S.C. 119 to Korean Patent Application No. 10-2022-0092665, filed on Jul. 26, 2022, in the Korean Intellectual Property Office, the disclosure of which is herein incorporated by reference in its entirety.

### BACKGROUND OF THE INVENTION

### 1. Field of the Invention

The present disclosure relates to a spent coffee ground brick and, more specifically, to a spent coffee ground brick with excellent durability and heat resistance.

### 2. Description of Related Art

Spent coffee grounds (SCG) are the residues obtained during the coffee brewing process. With the increase of global coffee consumption, the amount of spent coffee grounds that must be disposed of is increasing. Spent coffee grounds generated in 2020 and 2021 amounted to about 1.6 billion GBE (green bean equivalent) and are discharged as waste and are either landfilled or incinerated. Therefore, attention is being paid to a method that can efficiently dispose spent coffee grounds without an environmental problem.

One of the ways to reuse spent coffee grounds is to use spend coffee grounds as a substitute for fine aggregate (sand) contained in concrete bricks. Concrete bricks are manufactured by appropriately compounding cement, water, aggregate, and admixture materials and curing same. Coarse and/or fine aggregate is used. Typically, gravel and sand are used as coarse and fine aggregate, respectively. Sand, which is mainly used as a fine aggregate in concrete production, is not a renewable resource and adversely affects the environment during mining and transportation.

Attempts have been made to manufacture bricks containing spent coffee grounds. The prior art related to spent coffee ground-containing bricks is advantageous in terms of yielding environmental friendliness and light-weight bricks, but there are limitations in that the bricks are difficult to morphologically preserve, easily crack, and can be used only for decoration due to their vulnerability to flame. In addition, spent coffee ground-containing bricks require significant modifications of materials and equipment for their manufacture.

Therefore, there is a need for development of spent coffee ground-containing bricks that have improved durability and heat resistance and thus can safely retain their shape even when exposed to flames while allowing for compatibility with existing concrete brick manufacturing equipment.

### RELATED ART DOCUMENT

Patient Literature

Korean Patent Number 102028095

### SUMMARY OF THE INVENTION

The present disclosure aims to provide a spent coffee ground brick with improved durability and heat resistance.

The present disclosure also aims to provide a spent coffee ground brick that can be manufactured using a typical brick pressing machine without fabricating an additional brick manufacturing equipment or conducting particular modifications on the machine.

The present disclosure further aims to provide a spent coffee ground brick in which spent coffee grounds are substituted for up to 100% of sand used as fine aggregate, whereby the environmental damage caused by the use of sand and the disposal of spent coffee grounds can be reduced.

An aspect of the present disclosure provides a concrete brick containing spent coffee grounds.

The brick may include cement, coarse aggregate, fine aggregate, and water wherein the fine aggregate include spent coffee grounds.

The spent coffee grounds may be used in an amount to up to 100% by weight based on the total weight of the fine aggregate.

The brick may include 300 to 500 parts by weight of coarse aggregate, 30 to 60 parts by weight of spent coffee grounds, and 100 to 300 parts by weight of water, based on 100 parts by weight of cement.

With excellent durability and heat resistance, the spent coffee ground brick according to the present disclosure safely retain its shape and thus can be used in high-temperature environments.

In addition, the spent coffee ground brick is compatible with conventional concrete brick manufacturing equipment and thus can be manufactured immediately by conventional brick pressing machines without fabricating a separate brick manufacturing equipment or particularly modifying the machines.

Furthermore, the spent coffee ground brick allows for substitution of spent coffee grounds for sand by 100% and thus is environmentally favorable due to its ability to solve the environment problems with the use of sand and the disposal of spent coffee grounds.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a photographic image of bricks according to an embodiment of the present disclosure;

FIG. 2 is a photographic image showing the result of a quality control test for a brick according to an embodiment of the present disclosure;

FIGS. 3 and 4 are photographic images showing the results of quality control tests for bricks according to different embodiments of the present disclosure; and

FIGS. 5 and 6 are photographic images of a brazier constructed with bricks according to the present disclosure.

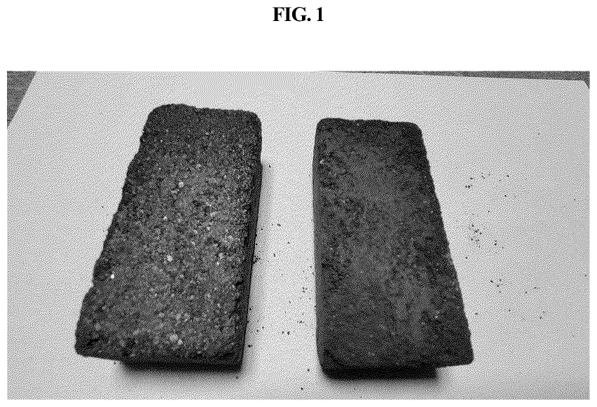

### DETAILED DESCRIPTION OF THE EXEMPLARY EMBODIMENTS

Below, a detailed description will be given of the present disclosure. However, the embodiments are given to illustrate the present disclosure, but are not to be construed to limit the scope of the present disclosure.

An aspect of the present disclosure provides a concrete brick including spent coffee grounds.

The brick may include cement, coarse aggregate, fine aggregate, and water, wherein the fine aggregate includes spent coffee grounds.

The brick may include 300 to 500 parts by weight of coarse aggregate, 30 to 60 parts by weight of spent coffee grounds, and 100 to 300 parts by weight of water, based on 100 parts by weight of cement.

The cement may be that used typically in the technical field to which the present disclosure belongs, and may be preferably Portland cement.

The coarse aggregate may be that used typically in the technical field to which the present disclosure belongs, and may be preferably gravel.

The fine aggregate may be that used typically in the technical field to which the present disclosure belongs, and may preferably include spent coffee grounds and may not include sand.

The spent coffee ground brick according to the present disclosure may employ spent coffee grounds in substitution for sand, which is typically used as fine aggregate, by up to 100%.

Existing attempts to manufacture spent coffee ground bricks by partially replacing sand with spent coffee grounds had a limitation in that the higher the content of spent coffee grounds, the lower the strength of spent coffee ground bricks.

The present disclosure provides a spent coffee ground brick which has spent coffee grounds in complete substitution for sand and exhibits durability and heat resistance.

In addition, conventional spent coffee ground bricks containing spent coffee grounds employ binders or substances to compensate for physical properties such as strength, etc.

The spent coffee ground brick of the present disclosure does not employ a binder and/or a different substance and exhibits sufficient durability even while using only spent coffee grounds as fine aggregate.

In addition, the spent coffee ground brick of the present disclosure can be manufactured immediately by conventional brick press machines.

The brick can be manufactured using a method typically used in the art to which the present disclosure belongs and preferably according to a typical process using a brick press machine.

A better understanding of the present disclosure may be obtained through the following examples, which are set forth to illustrate, but are not to be construed to limit the present disclosure.

<Manufacture of Bricks>

Bricks were manufactured by materials at the following ratios:

[Example] cement:coarse aggregate:spent coffee ground:water=1:4.0:0.4:1.7

[Comparative Example 1] cement:coarse aggregate:spent coffee ground:water=1:3.6:1.7:2.3

[Comparative Example 2] cement:coarse aggregate:spent coffee ground:water=1:3.0:1.4:2.4

[Comparative Example 3] cement:coarse aggregate:spent coffee ground:water=1:4.3:1.1:2.6

[Comparative Example 4] cement:coarse aggregate:spent coffee ground:water=1:5.4:2.5:4.3

The materials were compounded according to the ratios set forth above, and mixed by stirring. Then, the mixture was fed into a frame of a brick press machine and compressed and molded into a brick shape. The molded product was dried at room temperature for 3 weeks to obtain a brick.

The mixture according to the mixing ratio of Comparative Example 4 could not be prepared into a brick because it was unable to be molded into a brick shape.

<Quality Control Test>

The bricks of the Example and Comparative Examples 1 to 3 were subjected to quality control testing.

The quality control test was carried out by applying a pressure of 10 MPa to each brick for several minutes with a hydraulic press and monitoring the occurrence of cracks therein with the naked eye.

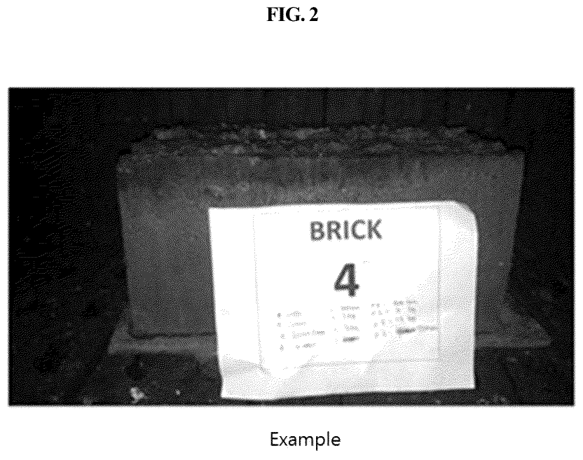

FIGS. 2 to 4 show states of the bricks after the test.

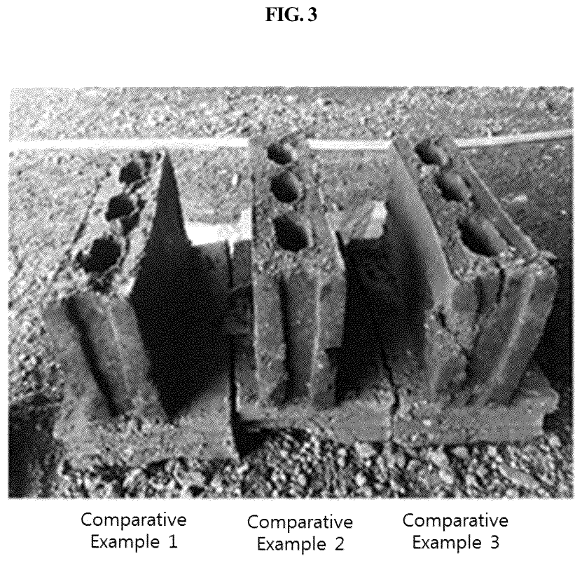

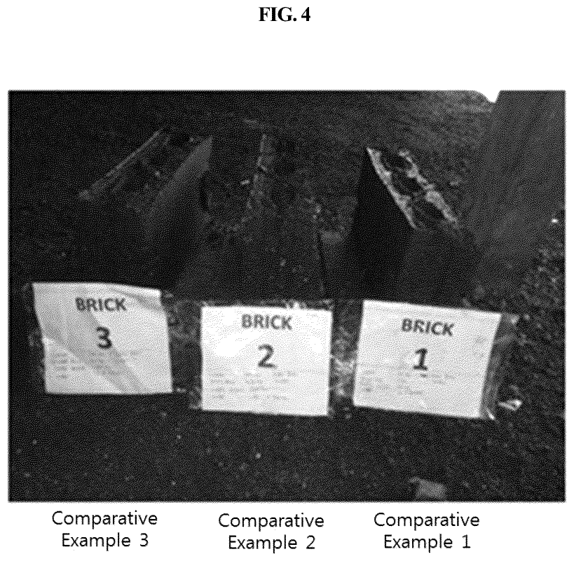

As shown in FIG. 2, the brick of the Example retained its shape without cracking. The bricks of the Comparative Examples were observed to crack with time as shown in FIGS. 3 and 4.

From the data of the quality control test, it was understood that the brick manufactured at the mixing ratio set forth in the Example was superior in terms of durability to the other bricks.

<Heat Resistance Test>

The brick manufactured in the Example was subjected to a heat resistance test. The heat resistant test was carried out by burning firewood in a brazier constructed with the bricks of the Example for 8 hours and monitoring stability of the brazier.

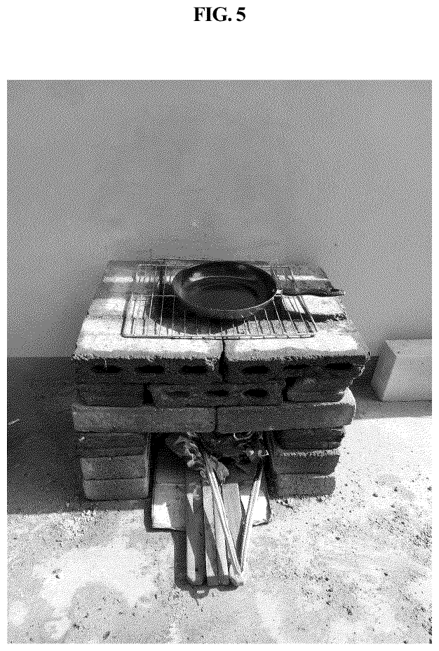

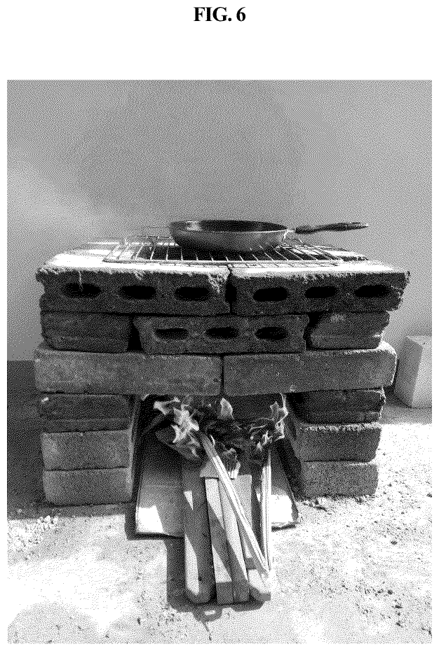

FIGS. 5 and 6 show states of the brazier after the test.

As shown in FIGS. 5 and 6, the brazier constructed with the bricks of the Example was observed to stably retain its shape even after exposure to flames for 8 hours.

From the data of the heat resistance test, it was understood that the brick manufactured at the mixing ratio of the Example had excellent heat resistance and could be used even in high-temperature environments such as braziers.

What is claimed is:

1. A spent coffee ground brick comprising:
cement;
coarse aggregate;
fine aggregate; and
water,
wherein the fine aggregate comprises spent coffee ground in an amount of 100% by weight based on a total weight thereof.

2. The spent coffee ground brick of claim 1, comprising 300 to 500 parts by weight of coarse aggregate, 30 to 60 parts by weight of spent coffee grounds, and 100 to 300 parts by weight of water, based on 100 parts by weight of cement.
